(19) United States
(12) Patent Application Publication
(10) Pub. No.: US 2016/0102002 A1
(43) Pub. Date: Apr. 14, 2016

(54) WATER TREATMENT

(71) Applicant: BWA WATER ADDITIVES UK LIMITED, MANCHESTER (GB)

(72) Inventor: JEFFREY KRAMER, SNELLVILLE, GA (US)

(21) Appl. No.: 14/513,735

(22) Filed: Oct. 14, 2014

(51) Int. Cl. C02F 1/76; A01N 59/02; A01N 57/20

(52) U.S. Cl. CPC C02F 1/76; A01N 57/20; A01N 59/02; C02F 2103/28

(57) ABSTRACT

The present invention relates to water treatment, In one example, there is provided a method of treating an aqueous system comprising dissolved solids to inhibit growth of one or more micro-organisms therein and/or to reduce the number of live micro-organisms therein. The method includes adding treatment agents to said aqueous system wherein said treatment agents include:
(a) a phosphonium compound; and
(b) a stabilised halogen containing composition.

### FIELD OF THE INVENTION

The present invention relates to water treatment, particularly though not exclusively, to methods of treating aqueous systems to inhibit growth of micro-organisms.

### BACKGROUND TO THE INVENTION

The presence and growth of micro-organisms in aqueous systems, especially in industrial water systems, is a concern. Examples of industrial water systems where micro-organisms are a concern include cooling water systems, pulping and papermaking systems and oil and gas field water systems.

The presence of micro-organisms in industrial water systems may result in the formation of deposits on system surfaces. These deposits or slime can give rise to various problems. In cooling water systems, slime may restrict water flow, reduce heat transfer efficiency, cause corrosion and may be aesthetically unappealing especially if algae are present due to their visible green pigmentation. Corrosion can also occur in industrial water systems in the absence of visible slime through the action of micro-organisms.

In pulp and paper mill systems, slime formed by micro-organisms may cause fouling, plugging, or corrosion of the system. The slime may also break loose and become entrained in the paper produced causing blemishes, holes, tears, and odour in the finished product. The end result may therefore be unusable product and wasted output.

Slime can also be a problem in oil and gas field water systems and may cause energy losses due to increased fluid frictional resistance, formation plugging and corrosion. The slime may harbour a mixture of aerobic and anaerobic bacteria that are responsible for the production of hydrogen sulfide gas. The hydrogen sulfide may cause souring of oil and gas which may reduce the quality of these products and increase treatment costs.

Pseudomonas aeruginosa bacteria are commonly present in air, water and soil. These bacteria continually contaminate open cooling water systems, pulping and papermaking systems and oil and gas field water systems and are among the most common slime formers. Slime may be viewed as being a mass of cells stuck together by the cementing action of the gelatinous secretions around each cell. The slime entraps other debris, restricts water flow and heat transfer and may serve as a site for corrosion.

Chlorella vulgaris algae are also commonly present in air, water and soil. These algae continually contaminate open cooling water systems and their growth turns the water and surfaces in these systems green. They also provide a food source for bacteria, which can stimulate slime formation, and protozoa which can harbour the pathogenic bacterium Legionella pneumophila.

A known method of controlling microbial growth in aqueous systems is to use biocides. While biocides are known to inhibit microbial growth the biocidal effect is generally of limited duration. The effectiveness of known biocides may be rapidly reduced as a result of exposure to negative influences. Negative influences may include temperature, pH or reaction with ingredients present in the system which neutralizes their biocidal effect. Therefore, the use of such biocides may involve continuous or frequent addition and their application at multiple sites or zones in the system to be treated. The cost of the biocide treatment and the labour costs associated with the application of known biocides may therefore be significant.

Known biocides are also highly toxic in the quantities known to be required for effective control of microbial populations. As a result, the amount of biocides that can be safely discharged into the environment may be limited by environmental regulations. Therefore, the need exists for improved methods for controlling microbial growth in aqueous systems.

As noted above, known biocides have a number of limitations including the large quantities of biocides which typically have to be used to achieve the desired biocidal effect and the potential harmful effects on the environment of biocides and therefore reducing the amount necessary for control and thus the quantity released to the environment has many benefits.

Accordingly, the present invention aims to address at least one disadvantage associated with the prior art whether discussed herein or otherwise.

### SUMMARY OF THE INVENTION

According to the present invention there is provided a method of treating an aqueous system as set forth in the appended claims. Other features of the invention will be apparent from the claims, and the description which follows.

According to a first aspect of the present invention there is provided a method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:

(a) a phosphonium compound; and
(b) a stabilised halogen containing composition.

The stabilised halogen containing composition (b) may comprise a stabiliser (c) and a halogen containing compound (d). Alternatively, or in addition, the stabilised halogen containing composition (b) may comprise a stabilised halogen containing compound (e).

Suitably, the stabilised halogen containing composition (b) comprises a chlorine containing composition. The stabilised halogen containing composition (b) may comprise a hypochlorite, for example sodium hypochlorite. The stabilised halogen containing composition (b) may comprise sulfamate stabilised halogen, for example sulfamate stabilised chlorine. The stabilised halogen containing composition (b) may comprise a chlorosulfamate.

The stabilised halogen containing composition (b) may comprise a nitrogen and sulfur based acid and/or salt thereof. The stabilised halogen containing composition (b) may comprise sulfamic acid and/or salt thereof.

The stabilised halogen containing composition (b) may comprise a bromine containing composition. The stabilised halogen containing composition (b) may comprise a bromide, for example sodium bromide.

Suitably, the halogen containing compound (d) comprises a chlorine containing compound. The halogen containing compound (d) may comprise a hypochlorite, for example sodium hypochlorite.

The halogen containing compound (d) may comprise a bromine containing compound. The halogen containing compound (d) may comprise a bromide, for example sodium bromide.

Suitably, the stabiliser (c) comprises an acid, for example sulfamic acid.

The stabilised halogen containing composition (b) may have a pH of greater than 11.0, for example greater than 11.5. The stabilised halogen containing composition (b) may have a pH of greater than 12.0, for example of 12.5 or greater.

The stabilised halogen containing composition (b) may comprise a base. The stabilised halogen containing composition (b) may comprise an alkali. The stabilised halogen containing composition (b) may comprise sodium hydroxide.

Suitably, the stabilised halogen containing compound (e) comprises a chlorine containing compound. Suitably, the stabilised halogen containing compound (e) comprises a sulfamate. Suitably, the stabilised halogen containing compound (e) comprises a chlorosulfamate.

The method may comprise adding a treatment agent comprising a combination of stabilised chlorine and bromide.

Suitably, the method comprises adding to an aqueous system a stabilised halogen containing composition (b) which comprises sodium hypochlorite stabilised with sulfamic acid to provide chlorosulfamate.

Suitably, the method comprises adding to an aqueous system a stabilised halogen containing composition (b) which comprises sodium hypochlorite stabilised with sulfamic acid to provide chlorosulfamate and which further comprises sodium hydroxide.

Suitably, the method comprises adding to an aqueous system a stabilised halogen containing composition (b) which comprises sodium hypochlorite stabilised with sulfamic acid to provide chlorosulfamate and which further comprises sodium hydroxide and sodium bromide.

Suitably, the stabilised halogen containing composition (b) has an activity of at least 1% as chlorine, for example at least: 2%; 3%; 4%; 5% or 6%. The stabilised halogen containing composition (b) may have an activity of less than 15% as chlorine, for example less than: 14%; 13%; 12%; 11%; or 10%. The stabilised halogen containing composition (b) may have an activity of from 5% to 10% as chlorine, for example from 6% to 8%.

Suitably, the method comprises treating an aqueous system to inhibit growth of anaerobic bacteria and/or to reduce the number of live anaerobic bacteria therein. Suitably, the method comprises treating an aqueous system to inhibit growth of facultative anaerobic bacteria and/or to reduce the number of live facultative anaerobic bacteria therein. Suitably, the method comprises treating an aqueous system to inhibit growth of aerobic bacteria and/or to reduce the number of live aerobic bacteria therein.

Suitably the aqueous system comprises a mixture of water and other constituents. The aqueous system may contain oil. The aqueous system may comprise an oil and water emulsion. The aqueous system may comprise solids. The aqueous system may comprise suspended solids. The aqueous system may comprise high levels of dissolved solids. The aqueous system may comprise one or more salts, for example sodium chloride.

Suitably, the method comprises treating an aqueous system having a total dissolved solids (TDS) of 1000 mg l⁻¹ or greater. Suitably, the aqueous system has a total dissolved solids (TDS) of at least 2000 mg l⁻¹, for example at least: 3000 mg l⁻¹; 4000 mg l⁻¹; 5000 mg l⁻¹; 6000 mg l⁻¹; 7000 mg l⁻¹; 8000 mg l⁻¹; or 9000 mg l⁻¹.

Suitably, the method comprises treating an aqueous system having a total dissolved solids (TDS) of 10,000 mg l⁻¹ or greater. Suitably, the aqueous system has a total dissolved solids (TDS) of at least 11,000 mg l⁻¹, for example at least: 12,000 mg l⁻¹; 13,000 mg l⁻¹; 14,000 mg l⁻¹; 15,000 mg l⁻¹; 16,000 mg l⁻¹; 17,000 mg l⁻¹; 18,000 mg l⁻¹; or 19,000 mg l⁻¹.

Suitably, the method comprises treating an aqueous system having a total dissolved solids (TDS) of 20,000 mg l⁻¹ or greater. Suitably, the aqueous system has a total dissolved solids (TDS) of at least 21,000 mg l⁻¹, for example at least: 22,000 mg l⁻¹; 23,000 mg l⁻¹; 24,000 mg l⁻¹; 25,000 mg l⁻¹; 26,000 mg l⁻¹; 27,000 mg l⁻¹; 28,000 mg l⁻¹; or 29,000 mg l⁻¹.

Suitably, the method comprises treating an aqueous system having a total dissolved solids (TDS) of 30,000 mg l⁻¹ or greater. Suitably, the aqueous system has a total dissolved solids (TDS) of at least 31,000 mg l⁻¹, for example at least: 32,000 mg l⁻¹; 33,000 mg l⁻¹; 34,000 mg l⁻¹; 35,000 mg l⁻¹; 36,000 mg l⁻¹; 37,000 mg l⁻¹; 38,000 mg l⁻¹; or 39,000 mg l⁻¹.

Suitably, the method comprises treating an aqueous system having a total dissolved solids (TDS) of 40,000 mg l⁻¹ or greater. Suitably, the aqueous system has a total dissolved solids (TDS) of at least 41,000 mg l⁻¹, for example at least: 42,000 mg l⁻¹; 43,000 mg l⁻¹; 44,000 mg l⁻¹; 45,000 mg l⁻¹; 46,000 mg l⁻¹; 47,000 mg l⁻¹; 48,000 mg l⁻¹; or 49,000 mg l⁻¹.

Suitably, the method comprises treating an aqueous system having a total dissolved solids (TDS) of 50,000 mg l⁻¹ or greater. Suitably, the aqueous system has a total dissolved solids (TDS) of at least 51,000 mg l⁻¹, for example at least: 52,000 mg l⁻¹; 53,000 mg l⁻¹; 54,000 mg l⁻¹; 55,000 mg l⁻¹; 56,000 mg l⁻¹; 57,000 mg l⁻¹; 58,000 mg l⁻¹; or 59,000 mg l⁻¹.

Suitably, the method comprises treating an aqueous system having a total dissolved solids (TDS) of 60,000 mg l⁻¹ or greater. Suitably, the aqueous system has a total dissolved solids (TDS) of at least 61,000 mg l⁻¹, for example at least: 62,000 mg l⁻¹; 63,000 mg l⁻¹; 64,000 mg l⁻¹; 65,000 mg l⁻¹; 66,000 mg l⁻¹; 67,000 mg l⁻¹; 68,000 mg l⁻¹; or 69,000 mg l⁻¹.

Suitably, the method comprises treating an aqueous system having a total dissolved solids (TDS) of 70,000 mg l⁻¹ or greater. Suitably, the aqueous system has a total dissolved solids (TDS) of at least 71,000 mg l⁻¹, for example at least: 72,000 mg l⁻¹; 73,000 mg l⁻¹; 74,000 mg l⁻¹; 75,000 mg l⁻¹; 76,000 mg l⁻¹; 77,000 mg l⁻¹; 78,000 mg l⁻¹; or 79,000 mg l⁻¹.

Suitably, the method comprises treating an aqueous system having a total dissolved solids (TDS) of 80,000 mg l⁻¹ or greater. Suitably, the aqueous system has a total dissolved solids (TDS) of at least 81,000 mg l⁻¹, for example at least: 82,000 mg l⁻¹; 83,000 mg l⁻¹; 84,000 mg l⁻¹; 85,000 mg l⁻¹; 86,000 mg l⁻¹; 87,000 mg l⁻¹; 88,000 mg l⁻¹; or 89,000 mg l⁻¹.

Suitably, the method comprises treating an aqueous system having a total dissolved solids (TDS) of 90,000 mg l⁻¹ or greater. Suitably, the aqueous system has a total dissolved solids (TDS) of at least 91,000 mg l⁻¹, for example at least: 92,000 mg l⁻¹; 93,000 mg l⁻¹; 94,000 mg l⁻¹; 95,000 mg l⁻¹; 96,000 mg l⁻¹; 97,000 mg l⁻¹; 98,000 mg l⁻¹; or 99,000 mg l⁻¹.

Suitably, the method comprises treating an aqueous system having a total dissolved solids (TDS) of 100,000 mg l⁻¹ or greater. The aqueous system may have a total dissolved solids (TDS) of at least 101,000 mg l⁻¹, for example at least: 102,000 mg l⁻¹; 103,000 mg l⁻¹; 104,000 mg l⁻¹; 105,000 mg l⁻¹; 106,000 mg l⁻¹; 107,000 mg l⁻¹; 108,000 mg l⁻¹; or 109,000 mg l⁻¹.

The method may comprise treating an aqueous system having a total dissolved solids (TDS) of 110,000 mg l⁻¹ or greater. The aqueous system may have a total dissolved solids (TDS) of at least 111,000 mg l⁻¹, for example at least: 112,000 mg l⁻¹; 113,000 mg l⁻¹; 114,000 mg l⁻¹; 115,000 mg l⁻¹; 116,000 mg l⁻¹; 117,000 mg l⁻¹; 118,000 mg l⁻¹; or 119,000 mg l⁻¹.

The method may comprise treating an aqueous system having a total dissolved solids (TDS) of 120,000 mg l⁻¹ or greater. The aqueous system may have a total dissolved solids (TDS) of at least 121,000 mg l⁻¹, for example at least: 122,000 mg l⁻¹; 123,000 mg l⁻¹; 124,000 mg l⁻¹; 125,000 mg l⁻¹; 126,000 mg l⁻¹; 127,000 mg l⁻¹; 128,000 mg l⁻¹; or 129,000 mg l⁻¹.

The method may comprise treating an aqueous system having a total dissolved solids (TDS) of 130,000 mg l⁻¹ or greater. The aqueous system may have a total dissolved solids (TDS) of at least 131,000 mg l⁻¹, for example at least: 132,000 mg l⁻¹; 133,000 mg l⁻¹; 134,000 mg l⁻¹; 135,000 mg l⁻¹; 136,000 mg l⁻¹; 137,000 mg l⁻¹; 138,000 mg l⁻¹; or 139,000 mg l⁻¹.

The method may comprise treating an aqueous system having a total dissolved solids (TDS) of 140,000 mg l⁻¹ or greater. The aqueous system may have a total dissolved solids (TDS) of at least 141,000 mg l⁻¹, for example at least: 142,000 mg l⁻¹; 143,000 mg l⁻¹; 144,000 mg l⁻¹; 145,000 mg l⁻¹; 146,000 mg l⁻¹; 147,000 mg l⁻¹; 148,000 mg l⁻¹; or 149,000 mg l⁻¹.

The method may comprise treating an aqueous system having a total dissolved solids (TDS) of 150,000 mg l⁻¹ or greater. The aqueous system may have a total dissolved solids (TDS) of at least 155,000 mg l⁻¹, for example at least: 160,000 mg l⁻¹; 165,000 mg l⁻¹; 170,000 mg l⁻¹; 175,000 mg l⁻¹; 180,000 mg l⁻¹; 185,000 mg l⁻¹; 190,000 mg l⁻¹; or 195,000 mg l⁻¹.

The aqueous system may have a total dissolved solids (TDS) of at least 200,000 mg l⁻¹, for example at least: 205,000 mg l⁻¹; 210,000 mg l⁻¹; 215,000 mg l⁻¹; 220,000 mg l⁻¹; 225,000 mg l⁻¹; 230,000 mg l⁻¹; 235,000 mg l⁻¹; 240,000 mg l⁻¹; or 245,000 mg l⁻¹.

The aqueous system may have a total dissolved solids (TDS) of at least 250,000 mg l⁻¹, for example at least: 260,000 mg l⁻¹; 270,000 mg l⁻¹; 280,000 mg l⁻¹; or 290,000 mg l⁻¹.

The aqueous system may have a total dissolved solids (TDS) of at least 300,000 mg l⁻¹; for example at least: 350,000 mg l⁻¹; 400,000 mg l⁻¹; 450,000 mg l⁻¹; or 500,000 mg l⁻¹.

Suitably, the method comprises treating an aqueous system having a total dissolved solids (TDS) of 1000,000 mg l⁻¹ or less. The aqueous system may have a total dissolved solids (TDS) of no more than 900,000 mg l⁻¹, for example no more than: 800,000 mg l⁻¹; 700,000 mg l⁻¹; or 600,000 mg l⁻¹.

The method may comprise treating an aqueous system having a total dissolved solids (TDS) of 500,000 mg l⁻¹ or less. The aqueous system may have a total dissolved solids (TDS) of no more than 450,000 mg l⁻¹, for example no more than 400,000 mg l⁻¹; 350,000 mg l⁻¹; 300,000 mg l⁻¹; or 250,000 mg l⁻¹. The aqueous system may have a total dissolved solids (TDS) of no more than 200,000 mg l⁻¹, for example no more than 150,000 mg l⁻¹.

Suitably, the method comprises treating an aqueous system having a total dissolved solids (TDS) of from 10,000 mg l⁻¹ to 1000,000 mg l⁻¹. Suitably, the aqueous system has a total dissolved solids (TDS) of from 20,000 mg l⁻¹ to 800,000 mg l⁻¹, for example from 30,000 mg l⁻¹ to 500,000 mg l⁻¹. Suitably, the aqueous system has a total dissolved solids (TDS) of from 40,000 mg l⁻¹ to 500,000 mg l⁻¹. Suitably, the aqueous system has a total dissolved solids (TDS) of from 50,000 mg l⁻¹ to 500,000 mg l⁻¹. Suitably, the method comprises treating an aqueous system having a total dissolved solids (TDS) of from 60,000 mg l⁻¹ to 500,000 mg l⁻¹, for example from 70,000 mg l⁻¹ to 500,000 mg l⁻¹; for example from 80,000 mg l⁻¹ to 500,000 mg l⁻¹ Suitably, the method comprises treating an aqueous system having a total dissolved solids (TDS) of from 90,000 mg l⁻¹ to 500,000 mg l⁻¹ for example from 100,000 mg l⁻¹ to 500,000 mg l⁻¹; for example from 110,000 mg l⁻¹ to 500,000 mg l⁻¹.

Suitably, the method comprises treating an aqueous system to inhibit the growth of a plurality of different micro-organisms.

Suitably, the method comprises treating an aqueous system to prevent the growth of one or more micro-organisms. Suitably, the method comprises treating an aqueous system to prevent the growth of a plurality of different micro-organisms.

Suitably, the method comprises treating an aqueous system to kill one or more micro-organisms. Suitably, the method comprises treating an aqueous system to kill a plurality of different micro-organisms.

Suitably, the method comprises treating an aqueous system to inhibit or prevent the growth of one or more micro-organisms therein and/or to reduce the number of live micro-organisms therein, wherein said micro-organisms are selected from bacteria, fungi and algae. Suitably, the method comprises a method of inhibiting growth of bacteria and/or killing bacteria. Suitably, the method comprises a method of inhibiting growth of fungi and/or killing fungi. Suitably, the method comprises a method of inhibiting growth of algae and/or killing algae.

Suitably, the method comprises treating an aqueous system to inhibit or prevent the growth of anaerobic micro-organisms. Suitably, the method comprises treating an aqueous system to kill anaerobic micro-organisms. Suitably, the method comprises treating an aqueous system to inhibit or prevent the growth of anaerobic bacteria. Suitably, the method comprises treating an aqueous system to kill anaerobic bacteria. Suitably, the method comprises treating an aqueous system to inhibit or prevent the growth of facultative anaerobic bacteria. Suitably, the method comprises treating an aqueous system to kill facultative anaerobic bacteria.

Suitably, the method comprises treating an aqueous system to inhibit or prevent the growth of aerobic micro-organisms. Suitably, the method comprises treating an aqueous system to kill aerobic micro-organisms. Suitably, the method comprises treating an aqueous system to inhibit or prevent the growth of aerobic bacteria. Suitably, the method comprises treating an aqueous system to kill aerobic bacteria.

Suitably, the method comprises treating an aqueous system to inhibit or prevent the growth of anaerobic and aerobic micro-organisms. Suitably, the method comprises treating an aqueous system to kill anaerobic and aerobic micro-organisms. Suitably, the method comprises treating an aqueous system to inhibit or prevent the growth of anaerobic and aerobic bacteria. Suitably, the method comprises treating an aqueous system to kill anaerobic and aerobic bacteria.

The method may comprise a method of inhibiting growth of gram-positive aerobic bacteria, gram-positive facultative anaerobic bacteria, gram-negative aerobic bacteria, gram-negative facultative anaerobic bacteria, gram-positive anaerobic bacteria and/or gram-negative anaerobic bacteria. The method may comprise a method of inhibiting growth of mold and/or yeast. The method may comprise a method of inhibiting the growth of blue green algae and/or green algae. Suitably, the method comprises a method of inhibiting the growth of gram-negative aerobic bacteria, gram-negative facultative anaerobic bacteria, gram-negative anaerobic bacteria, and green algae. Suitably, the method comprises inhibiting the growth of Pseudomonas aeruginosa bacteria in an aqueous system. Suitably, the method comprises inhibiting the growth of Enterobacter aerogenes bacteria in an aqueous system. Suitably, the method comprises inhibiting the growth of Desulfovibrio vulgaris bacteria in an aqueous system. Suitably, the method comprises inhibiting the growth of Chlorella vulgaris algae in an aqueous system.

Suitably, the method comprises adding a phosphonium compound treatment agent and a stabilised halogen containing composition treatment agent to an aqueous system such that a Log 10 reduction of 2 or greater in an anaerobe culture is obtained after a contact time of 1 hour. Suitably, the method comprises obtaining a Log 10 reduction of 3 or greater to an anaerobe culture after a contact time of 1 hour. Suitably, the method comprises obtaining a Log 10 reduction of 4 or greater to an anaerobe culture after a contact time of 1 hour.

Suitably, the method comprises adding a phosphonium compound, and a stabilised halogen containing composition to an aqueous system such that a complete kill of an anaerobe culture is obtained after a contact time of 1 hour.

Suitably, the method comprises obtaining a Log 10 reduction of 1 or greater to an anaerobe culture after a contact time of 24 hours. Suitably, the method comprises obtaining a Log 10 reduction of 2 or greater to an anaerobe culture after a contact time of 24 hours.

Suitably, the method comprises adding a phosphonium compound and a stabilised halogen containing composition to an aqueous system such that a complete kill of an anaerobe culture is obtained after a contact time of 24 hours.

Suitably, the method comprises adding a phosphonium compound and a stabilised halogen containing composition to an aqueous system such that a Log 10 reduction of 4 or greater in a facultative anaerobe culture is obtained after a contact time of 24 hours. Suitably, the method comprises obtaining a Log 10 reduction of 5 or greater to a facultative anaerobe culture after a contact time of 24 hours. Suitably, the method comprises obtaining a Log 10 reduction of 6 or greater to an aerobe culture after a contact time of 24 hours. The method may comprise obtaining a Log 10 reduction of 7 or greater to a facultative anaerobe culture after a contact time of 24 hours.

Suitably, the method comprises adding a phosphonium compound and a stabilised halogen containing composition to an aqueous system such that a complete kill of a facultative anaerobe culture is obtained after a contact time of 24 hours.

Suitably, the stabilised halogen containing composition (b) comprises a composition comprising a halogen containing compound (d) and/or a stabilised halogen containing compound (e) and the method comprises adding compound (a) and composition (b) to the aqueous system such that compound (a) and compound (d) and/or compound (e) are added to the aqueous system in a total amount of from 0.1 to 1000 parts by weight per one million parts by weight of said aqueous system (ppm), for example from 0.1 to 100 ppm.

As used herein, all references to ppm refer to parts per million by weight unless stated otherwise.

Suitably, the stabilised halogen containing composition (b) comprises a composition comprising a halogen containing compound (d) and/or a stabilised halogen containing compound (e) and the method comprises adding compound (a) and composition (b) to the aqueous system such that compound (a) and compound(s) (d)/(e) are present in the aqueous system in a total amount of from 0.1 to 1000 parts by weight per one million parts by weight of said aqueous system (ppm), for example from 0.1 to 100 ppm.

Suitably, the method comprises adding compound (a) and composition (b) to the aqueous system such that compounds (a) and compound(s) (d)/(e) and stabiliser (c) are added in a total amount of from 0.1 to 1000 parts by weight per one million parts by weight of said aqueous system (ppm).

Suitably, the method comprises adding compound (a) and composition (b) to the aqueous system such that compounds (a) and compound(s) (d)/(e) and stabiliser (c) are present in a total amount of from 0.1 to 1000 parts by weight per one million parts by weight of said aqueous system (ppm), for example from 0.1 to 100 ppm.

The method may comprise adding compound (a) and compound(s) (d)/(e) to the aqueous system such that they are added in a total amount of from 0.5 to 100 ppm The method may comprise adding compound (a) and compound(s) (d)/(e) to the aqueous system such that they are added in a total amount of from 0.5 to 70 ppm. Suitably, the method comprises adding compound (a) and compound(s) (d)/(e) to the aqueous system such that they are added in a total amount of from 1 to 60 ppm. Suitably, the method comprises adding compound (a) and compound(s) (d)/(e) to the aqueous system such that they are added in a total amount of from 5 to 55 ppm.

The method may comprise adding compound (a) and compound(s) (d)/(e) and stabiliser (c) to the aqueous system such that they are added in a total amount of from 0.5 to 100 ppm. The method may comprise adding compound (a) and compound(s) (d)/(e) and stabiliser (c) to the aqueous system such that they are added in a total amount of from 0.5 to 70 ppm. Suitably, the method comprises adding compound (a) and compound(s) (d)/(e) and stabiliser (c) to the aqueous system such that they are added in a total amount of from 1 to 60 ppm. Suitably, the method comprises adding compound (a) and compound(s) (d)/(e) and stabiliser (c) to the aqueous system such that they are added in a total amount of from 5 to 55 ppm.

Suitably, the method comprises adding a stabilised halogen containing composition (b) to an aqueous system in an amount of at least 10 ppm.

Suitably, the method comprises adding a stabilised halogen containing composition (b) comprising water and a halogen containing compound (d) and/or a stabilised halogen containing compound (e) to an aqueous system in an amount of at least 10 ppm, calculated based on the total amount of composition (b) added, Suitably, the method comprises adding a stabilised halogen containing composition (b) comprising water and sodium hypochlorite and/or chlorosulfamate to an aqueous system in an amount of at least 10 ppm, calculated based on the total amount of composition (b) added.

The method suitably comprises adding Justeq07 available from Justeq LLC as the stabilised halogen containing composition (b) and the method suitably comprises adding Justeq07 to an aqueous composition in an amount of at least 10 ppm.

Suitably, the method comprises adding a stabilised halogen containing composition (b) to an aqueous system in an amount of at least 10 ppm, for example at least 15 ppm; 20 ppm; 25 ppm; 30 ppm; 35 ppm; 40 ppm; or 45 ppm. Suitably, the method comprises adding a stabilised halogen containing composition (b) to an aqueous system in an amount of at least 50 ppm, for example, at least: 55 ppm; 60 ppm; 65 ppm; 70 ppm; or 75 ppm. The method may comprise adding halogen containing composition (b) to an aqueous system in an amount of at least 80 ppm; 85 ppm; 90 ppm; 95 ppm 100 ppm; 105 ppm; 110 ppm; 115 ppm; 120 ppm; 125 ppm; 130 ppm; 135 ppm; 140 ppm; 145 ppm; 150 ppm; 155 ppm; 160 ppm; 165 ppm; 170 ppm; 175 ppm; 180 ppm; 185 ppm; 190 ppm; 195 ppm or 200 ppm.

Suitably, the method comprises adding a stabilised halogen containing composition (b) comprising sodium hypochlorite and/or chlorosulfamate to an aqueous system such that said composition (b) is added in an amount of at least 10 ppm, for example at least 15 ppm; 20 ppm; 25 ppm; 30 ppm; 35 ppm; 40 ppm; or 45 ppm. Suitably, the method comprises adding a stabilised halogen containing composition (b) comprising sodium hypochlorite and/or chlorosulfamate to an aqueous system such that said composition (b) is added to an aqueous system in an amount of at least 50 ppm, for example, at least: 55 ppm; 60 ppm; 65 ppm; 70 ppm; or 75 ppm. The method may comprise adding halogen containing composition (b) comprising sodium hypochlorite and/or chlorosulfamate to an aqueous system such that said composition (b) is added to an aqueous system in an amount of at least 80 ppm; 85 ppm; 90 ppm; 95 ppm 100 ppm; 105 ppm; 110 ppm; 115 ppm; 120 ppm; 125 ppm; 130 ppm; 135 ppm; 140 ppm; 145 ppm; 150 ppm; 155 ppm; 160 ppm; 165 ppm; 170 ppm; 175 ppm; 180 ppm; 185 ppm; 190 ppm; 195 ppm or 200 ppm.

Suitably, the method comprises adding a stabilised halogen containing composition (b) to an aqueous system in an amount of not more than 1000 ppm, for example not more than 500 ppm. Suitably, the method comprises adding a stabilised halogen containing composition (b) to an aqueous system in an amount of not more than 400 ppm, for example not more than: 450 ppm; 400 ppm; 350 ppm; 300 ppm; 250 ppm; 200 ppm; or 150 ppm.

Suitably, the method comprises adding a phosphonium compound treatment agent to an aqueous system in an amount of at least 0.1 parts per million (ppm).

Suitably, the method comprises adding a phosphonium compound treatment agent to an aqueous system to provide a treated aqueous system comprising said phosphonium compound in an amount of at least 0.1 parts per million (ppm).

Suitably, the method comprises adding a phosphonium compound to an aqueous system such that it is added in an amount of at least 0.2 ppm. Suitably, the method comprises adding a phosphonium compound to an aqueous system such that it is added in an amount of at least 0.3 ppm, for example at least: 0.4 ppm; 0.5 ppm; 0.6 ppm; 0.7 ppm; 0.8 ppm; 0.9 ppm; or 1.0 ppm. Suitably, the method comprises adding a phosphonium compound to an aqueous system such that it is added in an amount of at least 1 ppm; for example at least 1.5 ppm; 2.0 ppm; 2.5 ppm; 3.0 ppm; 3.5 ppm; 4.0 ppm; 4.5 ppm; 5.0 ppm; 5.5 ppm; or 6.0 ppm. The method may comprise adding a phosphonium compound to an aqueous system such that it is added in an amount of at least 6 ppm, for example at least: 7 ppm; 8 ppm; 9 ppm; 10 ppm; 11 ppm; 12 ppm; 13 ppm; 14 ppm; 15 ppm; 16 ppm; 17 ppm; 18 ppm; 19 ppm; 20 ppm; 21 ppm; 22 ppm; 23 ppm; 24 ppm or 25 ppm. The method may comprise adding a phosphonium compound to an aqueous system such that it is added in an amount of at least 25 ppm, for example at least: 30 ppm; 35 ppm; 40 ppm; 45 ppm; or 50 ppm.

Suitably, the method comprises adding a phosphonium compound to an aqueous system such that it is present in an amount of at least 0.2 ppm. Suitably, the method comprises adding a phosphonium compound to an aqueous system such that it is present in an amount of at least 0.3 ppm, for example at least: 0.4 ppm; 0.5 ppm; 0.6 ppm; 0.7 ppm; 0.8 ppm; 0.9 ppm; or 1.0 ppm. Suitably, the method comprises adding a phosphonium compound to an aqueous system such that it is present in an amount of at least 1 ppm; for example at least 1.5 ppm; 2.0 ppm; 2.5 ppm; 3.0 ppm; 3.5 ppm; 4.0 ppm; 4.5 ppm; 5.0 ppm; 5.5 ppm; or 6.0 ppm. The method may comprise adding a phosphonium compound to an aqueous system such that it is present in an amount of at least 6 ppm, for example at least: 7 ppm; 8 ppm; 9 ppm; 10 ppm; 11 ppm; 12 ppm; 13 ppm; 14 ppm; 15 ppm; 16 ppm; 17 ppm; 18 ppm; 19 ppm; 20 ppm; 21 ppm; 22 ppm; 23 ppm; 24 ppm or 25 ppm. The method may comprise adding a phosphonium compound to an aqueous system such that it is present in an amount of at least 25 ppm, for example at least: 30 ppm; 35 ppm; 40 ppm; 45 ppm; or 50 ppm.

Suitably, the method comprises adding a phosphonium compound treatment agent to an aqueous system to provide a treated aqueous system comprising said phosphonium compound added in an amount of 5.0 to 100 ppm, for example 10.0 to 60.0 ppm, for example 10.0 to 50.0 ppm. Suitably, the method comprises adding a phosphonium compound treatment agent to an aqueous system to provide a treated aqueous system comprising said phosphonium compound added in an amount of 10 to 15 ppm, for example 12 to 13 ppm for example 12.5 ppm. Suitably, the method comprises adding a phosphonium compound treatment agent to an aqueous system to provide a treated aqueous system comprising said phosphonium compound added in an amount of 20 to 30 ppm, for example 23 to 27 ppm, for example 25 ppm. Suitably, the method comprises adding a phosphonium compound treatment agent to an aqueous system to provide a treated aqueous system comprising said phosphonium compound added in an amount of 45 to 55 ppm, for example 48 to 52 ppm, for example 50 ppm.

Suitably, the method comprises adding a phosphonium compound treatment agent to an aqueous system in an amount of not more than 100 ppm, for example not more than 70 ppm.

Suitably, the method comprises adding a phosphonium compound treatment agent to an aqueous system to provide a treated aqueous system comprising said phosphonium compound in an amount of not more than 100 ppm, for example not more than 70 ppm.

Suitably, the method comprises adding a phosphonium compound to an aqueous system such that it is added in an amount of not more than 65 ppm, for example not more than 60 ppm; 55 ppm; or 50 ppm. The method may comprise adding a phosphonium compound to an aqueous system such that it is added in an amount of not more than 50 ppm, for example not more than 45 ppm; 40 ppm; or 35 ppm. The method may comprise adding a phosphonium compound to an aqueous system such that it is added in an amount of not more than 30 ppm, for example not more than; 25 ppm; 20 ppm; 15 ppm; or 10 ppm.

Suitably, the method comprises adding a phosphonium compound to an aqueous system such that it is present in an amount of not more than 65 ppm, for example not more than 60 ppm; 55 ppm; or 50 ppm. The method may comprise adding a phosphonium compound to an aqueous system such that it is present in an amount of not more than 50 ppm, for example not more than 45 ppm; 40 ppm; or 35 ppm. The method may comprise adding a phosphonium compound to an aqueous system such that it is present in an amount of not more than 30 ppm, for example not more than; 25 ppm; 20 ppm; 15 ppm; or 10 ppm.

Suitably, the method comprises adding a stabilised halogen containing composition (b) to an aqueous system, wherein the composition (b) comprises a halogen containing compound (d) and/or a stabilised halogen containing compound (e) and wherein the method comprises adding the composition (b) such that said halogen containing compound (d) and/or said stabilised halogen containing compound (e) are added in a total amount of at least 0.1 parts per million (ppm).

Suitably, the method comprises adding a stabilised halogen containing composition (b) to an aqueous system, wherein the composition (b) comprises a halogen containing compound (d) and/or a stabilised halogen containing compound (e) and wherein the method comprises adding the composition (b) to provide a treated aqueous system comprising said halogen containing compound (d) and/or said stabilised halogen containing compound (e) in a total amount of at least 0.1 parts per million (ppm).

The method may comprise adding a hypohalite compound to an aqueous system in an amount of at least 0.1 parts per million (ppm). The method may comprise adding sodium hypochlorite to an aqueous system in an amount of at least 0.1 parts per million (ppm).

Suitably, the method comprises adding a hypohalite compound to an aqueous system to provide a treated aqueous system comprising said a hypohalite compound in an amount of at least 0.1 parts per million (ppm). The method may comprise adding sodium hypochlorite to an aqueous system to provide a treated aqueous system comprising sodium hypochlorite in an amount of at least 0.1 parts per million (ppm).

The method may comprise adding a halosulfamate compound to an aqueous system in an amount of at least 0.1 parts per million (ppm). The method may comprise adding chlorosulfamate to an aqueous system in an amount of at least 0.1 parts per million (ppm).

Suitably, the method comprises adding a halosulfamate compound to an aqueous system to provide a treated aqueous system comprising said a halosulfamate compound in an amount of at least 0.1 parts per million (ppm). The method comprises adding chlorosulfamate to an aqueous system to provide a treated aqueous system comprising chlorosulfamate in an amount of at least 0.1 parts per million (ppm).

Suitably, the method comprises adding a halogen containing compound (d) and/or stabilised halogen containing compound (e) to an aqueous system in a total amount of at least 0.2 ppm. Suitably, the method comprises adding compound (d) and/or compound (e) to an aqueous system such that they are added in a total amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding compound (d) and/or compound (e) to an aqueous system such that they are added in a total amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding compound (d) and/or compound (e) to an aqueous system such that they are added in a total amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

Suitably, the method comprises adding a halogen containing compound (d) and/or stabilised halogen containing compound (e) to an aqueous system such that they are present in a total amount of at least 0.2 ppm. Suitably, the method comprises adding compound (d) and/or compound (e) to an aqueous system such that they are present in a total amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding compound (d) and/or compound (e) to an aqueous system such that they are present in a total amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding compound (d) and/or compound (e) to an aqueous system such that they are present in a total amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

Suitably, the method comprises adding a chlorosulfamate to an aqueous system such that it is added in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a chlorosulfamate to an aqueous system such that it is added in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a chlorosulfamate to an aqueous system such that it is added in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

Suitably, the method comprises adding a chlorosulfamate to an aqueous system such that it is present in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a chlorosulfamate to an aqueous system such that it is present in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a chlorosulfamate to an aqueous system such that it is present in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

The method may comprise adding a hypochlorite to an aqueous system such that it is added in an amount of at least 0.2 ppm. The method may comprise adding a hypochlorite to an aqueous system such that it is added in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a hypochlorite to an aqueous system such that it is added in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a hypochlorite to an aqueous system such that it is added in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

The method may comprise adding a hypochlorite to an aqueous system such that it is present in an amount of at least 0.2 ppm. The method may comprise adding a hypochlorite to an aqueous system such that it is present in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a hypochlorite to an aqueous system such that it is present in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a hypochlorite to an aqueous system such that it is present in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

The method may comprise adding a stabiliser (c) to an aqueous system in an amount of at least 0.1 parts per million (ppm).

The method may comprise adding a stabiliser to an aqueous system to provide a treated aqueous system comprising said stabiliser in an amount of at least 0.1 parts per million (ppm). The method may comprise adding a stabiliser to an aqueous system such that it is added in an amount of at least 0.2 ppm. The method may comprise adding a stabiliser to an aqueous system such that it is added in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a stabiliser to an aqueous system such that it is added in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a stabiliser compound to an aqueous system such that it is added in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

The method may comprise adding a stabiliser to an aqueous system such that it is present in an amount of at least 0.2 ppm. The method may comprise adding a stabiliser to an aqueous system such that it is present in an amount of at least 0.3 ppm, for example at least: 0.4 ppm; 0.5 ppm; 0.6 ppm; 0.7 ppm; 0.8 ppm; 0.9 ppm; or 1.0 ppm. The method may comprise adding a stabiliser to an aqueous system such that it is present in an amount of at least 1.1 ppm; for example, at least: 1.2 ppm; 1.3 ppm; 1.4 ppm; 1.5 ppm; 1.6 ppm; 1.7 ppm; 1.8 ppm; 1.9 ppm; or 2.0 ppm. The method may comprise adding a stabiliser compound to an aqueous system such that it is present in an amount of at least 2.1 ppm, for example at least: 2.2 ppm; 2.3 ppm; 2.4 ppm; 2.5 ppm; 2.6 ppm; 2.7 ppm; 2.8 ppm; 2.9 ppm or 3.0 ppm.

Suitably, the method comprises adding a chlorosulfamate to an aqueous system in an amount of not more than 100 ppm, for example not more than 50 ppm. The method may comprise adding a chlorosulfamate to an aqueous system in an amount of not more than 20 ppm. The method may comprise adding a chlorosulfamate to an aqueous system in an amount of not more than 15 ppm, for example not more than 10 ppm; 9 ppm; 8 ppm; 7 ppm; or 6 ppm. Suitably, the method comprises adding a chlorosulfamate to an aqueous system in an amount of not more than 5.0 ppm; 4.5 ppm; 4.0 ppm; 3.5 ppm; or 3.0 ppm.

The method may comprise adding a chlorosulfamate to an aqueous system to provide a treated aqueous system comprising said chlorosulfamate in an amount of 0.1 to 100 ppm, suitably 0.5 top 50 ppm. The method may comprise adding a chlorosulfamate to an aqueous system to provide a treated aqueous system comprising said chlorosulfamate in an amount of 0.5 to 2.5 ppm. The method may comprise adding a chlorosulfamate to an aqueous system to provide a treated aqueous system comprising said chlorosulfamate in an amount of 0.5 to 1.5 ppm.

The method may comprise adding a hypochlorite to an aqueous system in an amount of not more than 100 ppm, for example not more than 50 ppm. The method may comprise adding a hypochlorite to an aqueous system in an amount of not more than 20 ppm. The method may comprise adding a hypochlorite to an aqueous system in an amount of not more than 15 ppm, for example not more than 10 ppm; 9 ppm; 8 ppm; 7 ppm; or 6 ppm. Suitably, the method comprises adding a hypochlorite to an aqueous system in an amount of not more than 5.0 ppm; 4.5 ppm; 4.0 ppm; 3.5 ppm; or 3.0 ppm.

The method may comprise adding a hypochlorite to an aqueous system to provide a treated aqueous system comprising said hypochlorite in an amount of 0.5 to 2.5 ppm. The method may comprise adding a hypochlorite to an aqueous system to provide a treated aqueous system comprising said hypochlorite in an amount of 0.5 to 1.5 ppm.

The method may comprise adding a stabiliser (c) to an aqueous system in an amount of 0.5 to 2.5 ppm. The method may comprise adding a stabiliser to an aqueous system in an amount of 0.5 to 1.5 ppm.

The method may comprise adding a stabiliser (c) to an aqueous system to provide a treated aqueous system comprising said stabiliser in an amount of 0.5 to 2.5 ppm. The method may comprise adding a stabiliser to an aqueous system to provide a treated aqueous system comprising said stabiliser in an amount of 0.5 to 1.5 ppm.

Suitably, the method comprises adding a phosphonium compound (a) and a stabilised halogen containing composition (b) to an aqueous system in a weight ratio, expressed as active compound and composition, respectively, of phosphonium compound:stabilised halogen containing composition of from 1.0:0.5 to 1.0:100.0, for example from 1.0:0.5 to 1.0:20.0.

As used herein, all ratios are weight ratios unless stated otherwise.

Suitably the method comprises adding a phosphonium compound (a) and a stabilised halogen containing composition (b) to an aqueous system to provide a treated aqueous system comprising said phosphonium compound (a) and said stabilised halogen containing composition (b) in a weight ratio, expressed as active compound and composition, respectively, of phosphonium compound:stabilised halogen containing composition of from 1.0:0.5 to 1.0:100.0, for example from 1.0:0.5 to 1.0:20.0.

Suitably the method comprises adding a phosphonium compound (a) and a stabilised halogen containing composition (b) to an aqueous system to provide a treated aqueous system comprising said phosphonium compound (a) and said stabilised halogen containing composition (b) in a weight ratio, expressed as active compound and composition, respectively, of phosphonium compound:stabilised halogen containing composition of at least 1.0:100.0, for example of at least: 1.0:50.0, for example at least 1.0:20.0.

Suitably the method comprises adding a phosphonium compound (a) and a stabilised halogen containing composition (b) to an aqueous system to provide a treated aqueous system comprising said phosphonium compound (a) and said stabilised halogen containing composition (b) in a weight ratio, expressed as active compound and composition, respectively, of phosphonium compound:stabilised halogen containing composition of no greater than 1.0:0.5, for example no greater than 1.0:0.6.

The method may comprise adding a combination of phosphonium compounds (a) to an aqueous system. Suitably, the method comprises adding a single type of phosphonium compound (a) to an aqueous system.

Suitably, the method employs a phosphonium compound (a) having formula:

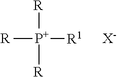

wherein each R is independently a C₁-C₆ alkyl group which is unsubstituted or substituted by a cyano, hydroxyl, esterified hydroxyl or aryl group;
R¹ represents a C₈-C₁₈ alkyl group which is substituted or unsubstituted; and
X represents either chlorine or bromine.

Suitably, each R is a C₁-C₆ alkyl group. Suitably, each R is a C₃-C₅ alkyl group. Suitably each R is a butyl group.

Suitably R¹ represents a C₈-C₁₈ alkyl group. Suitably, R1 is a C₁₂-C₁₆ alkyl group. Suitably, R¹ is a tetradecyl group.

Suitably, X is chlorine.

Suitably, the method employs a phosphonium compound (a) which is a phosphonium chloride.

Suitably, the method comprises treating an aqueous system such that phosphonium chloride comprises greater than 50% of the total phosphonium compound(s) added to the aqueous system. Suitably, the method comprises treating an aqueous system such that phosphonium chloride comprises greater than 90% of the total phosphonium compound(s) added to the aqueous system, for example 99% or greater.

Suitably, the method comprises treating an aqueous system such that phosphonium chloride comprises greater than 50% of the total phosphonium compound(s) present in the aqueous system. Suitably, the method comprises treating an aqueous system such that phosphonium chloride comprises greater than 90% of the total phosphonium compound(s) present in the aqueous system, for example 99% or greater.

Suitably, the method employs a phosphonium chloride as the only phosphonium compound (a).

Suitably, the method comprises adding tri n-butyl n-tetradecyl phosphonium chloride (hereafter “TTPC”) to the aqueous system. Suitably, the phosphonium compound (a) comprises TTPC. Suitably, the phosphonium compound (a) consists of TTPC.

Suitably, the method comprises adding an aqueous composition containing the phosphonium compound (a) to the aqueous system. Suitably, the method comprises adding an aqueous composition of TTPC to the aqueous system. The method may comprise adding an aqueous composition comprising 5% by weight of TTPC to the aqueous system. A suitable composition containing TTPC is available from BWA Water Additives and is sold under the trade name Bellacide 355 (an aqueous composition of TTPC and water consisting of water and 5% by weight of TTPC). The method may comprise adding an aqueous composition comprising 50% by weight of TTPC to the aqueous system. A suitable composition containing TTPC is available from BWA Water Additives and is sold under the trade name Bellacide 350 (an aqueous composition of TTPC and water consisting of water and 50% by weight of TTPC).

Suitably, the method comprises treating an aqueous system such that TTPC comprises greater than 50% of the total phosphonium compound(s) added to the aqueous system. Suitably, the method comprises treating an aqueous system such that TTPC comprises greater than 90% of the total phosphonium compound(s) added to the aqueous system, for example 99% or greater.

Suitably, the method comprises treating an aqueous system such that TTPC comprises greater than 50% of the total phosphonium compound(s) present in the aqueous system. Suitably, the method comprises treating an aqueous system such that TTPC comprises greater than 90% of the total phosphonium compound(s) present in the aqueous system, for example 99% or greater.

Suitably, the method employs TTPC as the only phosphonium compound (a).

The method may comprise adding a combination of halogen containing compounds (d) to an aqueous system. The method may comprise adding a combination of stabilised halogen containing compounds (e) to an aqueous system. The method may comprise adding a combination of halogen containing compounds (d) and stabilised halogen containing compounds (e) to an aqueous system. The method may comprise adding a combination of halogen containing compounds (d), stabilised halogen containing compounds (e) and stabiliser (c) to an aqueous system.

Suitably, the method employs a halogen containing compound (d) comprising a hypohalite. Suitably, the method employs a halogen containing compound (d) comprising a hypochlorite. The halogen containing compound (d) may consist of a hypochlorite. Suitably, the method employs a halogen containing compound (d) comprising a sodium hypohalite. The halogen containing compound (d) may consist of a sodium hypochlorite.

The method may comprise adding a combination of hypohalite compounds to an aqueous system. Suitably, the method comprises adding a single type of hypohalite compound to an aqueous system.

The method may comprise treating an aqueous system such that sodium hypochlorite comprises greater than 50% of the total hypohalite compounds added to the aqueous system. The method may comprise treating an aqueous system such that sodium hypochlorite comprises greater than 90% of the total hypohalite compounds added to the aqueous system, for example 99% or greater.

Suitably, the method employs a stabilised halogen containing compound (e) comprising chlorosulfamate. The stabilised halogen containing compound (e) may consist of a chlorosulfamate.

Suitably, the method comprises treating an aqueous system such that chlorosulfamate comprises greater than 50% of the total compounds comprising halogen (including both compounds (d) and (e)) added to the aqueous system. Suitably, the method comprises treating an aqueous system such that chlorosulfamate comprises greater than 90% of the total compounds comprising halogen (including both compounds (d) and (e)) added to the aqueous system, for example 99% or greater.

A suitable composition comprising chlorosulfamate is Justeq07 available from Justeq LLC.

The method may employ a synergistic mixture of compound (a) and composition (b). Suitably, by “synergistic mixture” it is meant that the mixture of compounds (a) and composition (b) has a synergistic effect on the inhibition of growth of one or more biological organisms, preferably micro-organisms such as bacteria, fungi and/or algae and/or has a synergistic effect on reducing the number of one or more biological organisms, preferably micro-organisms such as bacteria, fungi and/or algae.

The method may comprise adding compound (a) and composition (b) to the aqueous system such that the aqueous system comprises a synergistic mixture of compound (a) and composition (b).

The method may comprise adding compound (d) and stabiliser (c) to the aqueous system. The method may comprise adding composition (b) comprising compound (d) and stabiliser (c) as a mixture to the aqueous system. Alternatively, the method may comprise adding compound (d) and stabiliser (c) together to the aqueous system to form composition (b) within the system.

The method may comprise adding compound (e) to the aqueous system. The method may comprise adding composition (b) comprising compound (e) to the aqueous system. Composition (b) may further comprise compound (d) and stabiliser (c) in addition to compound (e).

The method may comprise adding compounds (a) and (d) and (e) and stabiliser (c) as a mixture to the aqueous system. The method may comprise adding compound (a) to the aqueous system separately from compounds (d) and (e) and stabiliser (c) and allowing or causing them to mix within the aqueous system.

The method may comprise adding compound (a) and composition (b) as a mixture to the aqueous system. The method may comprise adding compound (a) and composition (b) separately to the aqueous system and allowing or causing them to mix within the aqueous system.

Where the method comprises mixing compound (a) and compounds (d)/(e) and adding the mixture to the aqueous system and/or adding compound (a) and compounds (d)/(e) separately to the aqueous system and allowing or causing them to mix within the aqueous system then compound (a) and compounds (d)/(e) are suitably used in the form of aqueous compositions.

Suitably, compound (a) is used in the form of an aqueous composition comprising between 1% and 90% by weight of compound (a), for example between 1% and 60% by weight. Suitably, compound (a) is used in the form of an aqueous composition comprising between 1% and 10% by weight of compound (a), for example 5% by weight.

Composition (b) may comprise an aqueous composition comprising compounds (d)/(e) in an amount of between 1% and 90% by weight of compounds (d)/(e), for example between 1% and 50% by weight of the composition. Suitably, compounds (d)/(e) are used in the form of an aqueous composition comprising between 1% and 10% by weight of compounds (d)/(e), for example 7% by weight.

Composition (b) may further comprise stabiliser (c) in an amount of between 1% and 90% by weight of the composition, for example between 1% and 15% by weight.

The method may comprise a method of treating an industrial water system. The method may comprise treating a cooling water system. The method may comprise treating a pulping and/or papermaking water system. The method may comprise treating an oil and/or gas field water system. The method may comprise treating an aqueous system to control the growth of bacterial and/or algal micro-organisms contained therein and/or which may become entrained in said system.

It has been found that the compositions and methods of utilisation of the present invention may in particular be efficacious in controlling acid producing facultative anaerobic bacteria and hydrogen sulphide producing anaerobic bacteria which may populate aqueous systems.

Surprisingly, it has been found that when compound (a) and composition (b) are combined the resulting combination may pose a higher degree of biocidal activity in an aqueous system than that of the individual compounds used alone. Because of the enhanced activity of the combination of treatment agent compounds, it may be possible for the total quantity of treatment agent added to an aqueous system to be reduced in comparison to a system using only one of said treatment agent compounds. In addition, the high degree of biocidal activity which is provided by each of the treatment agent compounds may be exploited without use of higher concentrations of each. The combination of TTPC and sulfamic acid stabilised sodium hypochlorite may be particularly effective. The composition may also be surprisingly effective in systems having high total dissolved solids (TDS).

It has been found that the compositions and methods of utilisation of the present invention may in particular be efficacious in controlling the facultative anaerobic bacterium Enterobacter aerogenes and/or the anaerobic bacterium Desulfovibrio vulgaris, which may populate aqueous systems.

Surprisingly, the present inventor has found that mixtures of compound (a) and composition (b) such as mixtures of tri-n-butyl n-tetradecyl phosphonium chloride (TTPC) and sulfamic acid stabilised sodium hypochlorite are especially efficacious in controlling the growth of micro-organisms such as bacterial and algal microbes in aqueous systems comprising dissolved solids. The efficacy in relation to acid and sulphide producing bacteria is marked with certain selections of amounts and ratios of components and there is an unexpected synergistic relationship. It has been found that compositions of compound (a) and composition (b) are unexpectedly effective against anaerobes such as Desulfovibrio vulgaris [It has been found that such compositions may have a marked synergy in relation to facultative anaerobes such as Enterobacter aerogenes].

It has been found that compositions are unexpectedly effective against anaerobes. For example, stabilised chlorine may have some biocidal activity against anaerobes but the addition of TTPC may improve performance by two orders of magnitude. It has been found that compositions are unexpectedly effective against aerobes. For example, stabilised chlorine may have poor biocidal activity against facultative anaerobes but the addition of TTPC may greatly improve performance and may essentially allow for complete kill at 24 hours.

According to a second aspect of the present invention there is provided a method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:

(i) tri n-butyl n-tetradecyl phosphonium chloride (TTPC); and
(ii) chlorosulfamate.

Suitably, the aqueous system comprises greater than 20,000 mg l⁻¹ total dissolved solids (TDS). The aqueous system may comprise greater than 50,000 mg l⁻¹ TDS, for example greater than 100,000 mg l⁻¹ TDS.

Suitably, the treatment agents comprise:

(i) tri n-butyl n-tetradecyl phosphonium chloride (TTPC); and
(ii) a composition comprising chlorosulfamate formed by the combination of sulfamic acid with sodium hypochlorite.

The treatment agents may comprise a composition (ii) comprising chlorosulfamate and sodium hypochlorite. The composition (ii) may further comprise sulfamic acid. The composition (ii) may further comprise sodium hydroxide. The composition (ii) may further comprise sodium bromide.

The method of the second aspect may comprise any feature as described in relation to the first aspect except where such features are mutually exclusive.

According to a third aspect of the present invention there is provided a method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:

(i) tri n-butyl n-tetradecyl phosphonium chloride (TTPC); and
(ii) stabilised sodium hypochlorite.

Suitably, the aqueous system comprises greater than 20,000 mg l⁻¹ total dissolved solids (TDS). The aqueous system may comprise greater than 50,000 mg l⁻¹ TDS, for example greater than 100,000 mg l⁻¹ TDS.

Suitably, the treatment agents comprise:

(i) tri n-butyl n-tetradecyl phosphonium chloride (TTPC); and
(ii) a composition comprising sodium hypochlorite stabilised by sulfamic acid.

The treatment agents may comprise a composition (ii) comprising chlorosulfamate and sodium hypochlorite. The composition (ii) may further comprise sulfamic acid. The composition (ii) may further comprise sodium hydroxide. The composition (ii) may further comprise sodium bromide.

The method of the third aspect may comprise any feature as described in relation to one or more of the first and/or second aspects except where such features are mutually exclusive.

According to a fourth aspect of the present invention there is provided an aqueous system comprising dissolved solids and incorporating a combination of:

(a) a phosphonium compound; and
(b) a stabilised halogen containing composition.

Suitably, the aqueous system comprises greater than 20,000 mg l⁻¹ total dissolved solids (TDS). The aqueous system may comprise greater than 50,000 mg l⁻¹ TDS, for example greater than 100,000 mg l⁻¹ TDS.

Suitably, said compound (a) comprises TTPC.

Said composition (b) may comprise a stabiliser (c) and a halogen containing compound (d). Alternatively, or in addition, said composition (b) may comprise a stabilised halogen containing compound (e).

Suitably, the stabilised halogen containing composition (b) comprises a chlorine containing composition. The stabilised halogen containing composition (b) may comprise sulfamate stabilised chlorine. The stabilised halogen containing composition (b) may comprise sodium hypochlorite stabilised with sulfamic acid. The stabilised halogen containing composition (b) may comprise sodium hydroxide.

The aqueous system of the fourth aspect may comprise any feature as described in relation to one or more of the first and/or second and/or third aspects except where such features are mutually exclusive.

According to a fifth aspect of the present invention there is provided a method of inhibiting or preventing the growth of one or more micro-organisms in an aqueous media, wherein the method comprises adding treatment agents to an aqueous media comprising dissolved solids and wherein said treatment agents comprise:

(a) a phosphonium compound; and
(b) a stabilised halogen containing composition.

Suitably, the aqueous system comprises greater than 20,000 mg l⁻¹ total dissolved solids (TDS). The aqueous system may comprise greater than 50,000 mg l⁻¹ TDS, for example greater than 100,000 mg l⁻¹ TDS.

Suitably, said compound (a) comprises TTPC.

Said composition (b) may comprise a stabiliser (c) and a halogen containing compound (d). Alternatively, or in addition, said composition (b) may comprise a stabilised halogen containing compound (e).

Suitably, the stabilised halogen containing composition (b) comprises a chlorine containing composition. The stabilised halogen containing composition (b) may comprise sulfamate stabilised chlorine. The stabilised halogen containing composition (b) may comprise sodium hypochlorite stabilised with sulfamic acid. The stabilised halogen containing composition (b) may comprise sodium hydroxide.

The method of the fifth aspect may comprise any feature as described in relation to one or more of the first and/or second and/or third and/or fourth aspects except where such features are mutually exclusive.

According to a sixth aspect of the present invention there is provided an aqueous media comprising dissolved solids and incorporating a combination of:

(a) a phosphonium compound; and
(b) a stabilised halogen containing composition.

Suitably, the aqueous system comprises greater than 20,000 mg l⁻¹ total dissolved solids (TDS). The aqueous system may comprise greater than 50,000 mg l⁻¹ TDS, for example greater than 100,000 mg l⁻¹ TDS.

Suitably, said compound (a) comprises TTPC.

Said composition (b) may comprise a stabiliser (c) and a halogen containing compound (d).

Alternatively, or in addition, said composition (b) may comprise a stabilised halogen containing compound (e).

Suitably, the stabilised halogen containing composition (b) comprises a chlorine containing composition. The stabilised halogen containing composition (b) may comprise sulfamate stabilised chlorine. The stabilised halogen containing composition (b) may comprise sodium hypochlorite stabilised with sulfamic acid. The stabilised halogen containing composition (b) may comprise sodium hydroxide.

The aqueous media of the sixth aspect may comprise any feature as described in relation to one or more of the first and/or second and/or third and/or fourth and/or fifth aspects except where such features are mutually exclusive.

According to a seventh aspect of the present invention there is provided a biocidal composition comprising a combination of:

(a) a phosphonium compound; and
(b) a stabilised halogen containing composition.

Suitably, said compound (a) comprises TTPC.

Said composition (b) may comprise a stabiliser (c) and a halogen containing compound (d). Alternatively, or in addition, said composition (b) may comprise a stabilised halogen containing compound (e).

Suitably, the stabilised halogen containing composition (b) comprises a chlorine containing composition. The stabilised halogen containing composition (b) may comprise sulfamate stabilised chlorine. The stabilised halogen containing composition (b) may comprise sodium hypochlorite stabilised with sulfamic acid. The stabilised halogen containing composition (b) may comprise sodium hydroxide.

The biocidal composition of the seventh aspect may comprise any feature as described in relation to one or more of the first and/or second and/or third and/or fourth and/or fifth and/or sixth aspects except where such features are mutually exclusive.

According to an eighth aspect of the present invention there is provided a method of treating an aqueous system to inhibit growth of one or more micro-organisms therein and/or to reduce the number of live micro-organisms therein, wherein the method comprises adding treatment agents to said aqueous system and wherein said treatment agents comprise:

(a) a phosphonium compound; and
(b) a stabilised halogen containing composition.

The method of the eighth aspect may comprise any feature as described in relation to one or more of the first and/or second and/or third and/or fourth and/or fifth and/or sixth and/or seventh aspects except where such features are mutually exclusive.

### DETAILED DESCRIPTION OF PREFERRED EMBODIMENTS

The present invention will now be illustrated by way of example with reference to the following preferred embodiments.

### Examples

Aqueous systems were treated by adding treatment agents comprising: (a) a phosphonium compound and (b) a stabilised halogen containing composition. The phosphonium compound (a) used was TTPC. The stabilised halogen containing composition (b) was a stabilised chlorine composition which comprised sodium hypochlorite stabilised with sulfamic acid to give chlorosulfamate.

A suspension of Desulfovibrio vulgaris plus Enterobacter aerogenes bacteria containing from 1×10⁶ to 1×10⁸ cells/mL was prepared in sterile pH 7 phosphate buffer containing varying levels of sodium chloride to give the desired total dissolved solids (TDS) concentration. Aliquots of this suspension were dosed with the indicated concentrations of phosphonium compound (a) and stabilised halogen containing composition (b) with the concentrations being measured as ppm by weight of the stated composition in the dosed suspension. The mixtures were allowed to stand at room temperature. At the designated contact times, each mixture was sampled to determine the total number of viable cells of both Desulfovibrio vulgaris and Enterobacter aerogenes by serial 10-fold dilution into API RP 38 media vials and anaerobic acid producing media vials, respectively. The vials were incubated at 37° C. for 72 hours. Results were recorded as cells per milliliter.

Aqueous media inoculated with anaerobe and aerobe culture and having a TDS of 100,000 mg l⁻¹ was treated with treatment agents comprising: (i) stabilised halogen containing composition; (ii) tri n-butyl n-tetradecyl phosphonium chloride (TTPC) or (iii) a combination of stabilised halogen containing composition and TTPC.

TTPC was used in the form of Bellacide 350, an aqueous composition of TTPC and water consisting of water and 50% by weight of TTPC.

The stabilised halogen containing composition comprised sodium hypochlorite stabilised by the addition of sulfamic acid to provide chlorosulfamate and the composition used was Justeq07 available from Justeq LLC. This composition further comprises bromide and sodium hydroxide. The activity of the composition is approximately 6.7% as chlorine.

The efficacy of the treatment agents was evaluated by measuring the Log 10 Reduction of the anaerobic bacterium Desulfovibrio vulgaris and the facultative anaerobeic bacterium Enterobacter aerogenes after contact times of 1 hour and 24 hours as detailed in Tables 1 and 2. For TTPC the stated ppm value relates to the amount of TTPC added (active). For the stabilised chlorine composition the stated ppm relates to the amount of Justeq07 added (product).

TABLE 1

| | | | Treatment | | | |
|---|---|---|---|---|---|---|
| | | | agent (ppm) | | | |
| | | | | Stabilised | Log10 | |
| | | Con- | | chlorine | Re- | Log10 |
| | | tact | TTPC | compo- | duction | Reduction |
| | TDS | time | (as | sition (as | An- | Facultative |
| Example | (mg l⁻¹) | (hours) | active) | product) | aerobes | Anaerobes |
| 1 (com- | 100,000 | 1 | 0 | 75 | 2 | 0 |
| parative) | | | | | | |
| 2 (com- | 100,000 | 1 | 0 | 105 | 0 | 0 |
| parative) | | | | | | |
| 3 (com- | 100,000 | 1 | 6.25 | 0 | 0 | 0 |
| parative) | | | | | | |
| 4 (com- | 100,000 | 1 | 12.5 | 0 | 0 | 0 |
| parative) | | | | | | |
| 5 (com- | 100,000 | 1 | 25 | 0 | 0 | 0 |
| parative) | | | | | | |
| 6 (com- | 100,000 | 1 | 50 | 0 | 0 | 0 |
| parative) | | | | | | |
| 7 | 100,000 | 1 | 6.25 | 75 | 2 | 0 |
| 8 | 100,000 | 1 | 12.5 | 75 | 4 | 0 |
| 9 | 100,000 | 1 | 25 | 75 | 4 | 0 |
| 10 | 100,000 | 1 | 50 | 75 | 4 | 0 |
| 11 | 100,000 | 1 | 6.25 | 105 | 1 | 0 |
| 12 | 100,000 | 1 | 12.5 | 105 | 2 | 0 |
| 13 | 100,000 | 1 | 25 | 105 | 2 | 0 |
| 14 | 100,000 | 1 | 50 | 105 | 2 | 0 |

TABLE 2

| | | | Treatment | | | |
|---|---|---|---|---|---|---|
| | | | agent (ppm) | | Log10 | |
| | | | | Stabilised | Re- | Log10 |
| | | Contact | TTPC | chlorine | duction | Re- |
| | TDS | time | (as | composition | An- | duction |
| Example | (mg l⁻¹) | (hours) | active) | (as product) | aerobes | Aerobes |
| 15 (com- | 100,000 | 24 | 0 | 75 | 2 | 1 |
| parative) | | | | | | |
| 16 (com- | 100,000 | 24 | 0 | 105 | 2 | 1 |
| parative) | | | | | | |
| 17 (com- | 100,000 | 24 | 6.25 | 0 | 0 | 0 |
| parative) | | | | | | |
| 18 (com- | 100,000 | 24 | 12.5 | 0 | 0 | 0 |
| parative) | | | | | | |
| 19 (com- | 100,000 | 24 | 25 | 0 | 0 | 0 |
| parative) | | | | | | |
| 20 (com- | 100,000 | 24 | 50 | 0 | 0 | 0 |
| parative) | | | | | | |
| 21 | 100,000 | 24 | 6.25 | 75 | 2 | 5 |
| 22 | 100,000 | 24 | 12.5 | 75 | 2 | 6 |
| 23 | 100,000 | 24 | 25 | 75 | 2 | 5 |
| 24 | 100,000 | 24 | 50 | 75 | 2 | 6 |
| 25 | 100,000 | 24 | 6.25 | 105 | 2 | 7 |
| 26 | 100,000 | 24 | 12.5 | 105 | 2 | 7 |
| 27 | 100,000 | 24 | 25 | 105 | 2 | 7 |
| 28 | 100,000 | 24 | 50 | 105 | 2 | 7 |

It can be seen from the Examples that with a TDS of 100,000 mg l⁻¹ stabilised chlorine shows some biocidal activity against anaerobes but the addition of 12.5 ppm of TTPC surprisingly improved the performance by 2 orders of magnitude with a 1 hour contact time. It can also be seen that although stabilised chlorine has poor biocidal activity against aerobes the addition of as little as 6.25 ppm of TTPC greatly improves performance essentially providing complete kill at 24 hours.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:
(a) a phosphonium compound; and
(b) a stabilised halogen containing composition.

2. A method according to claim 1, wherein the stabilised halogen containing composition (b) comprises a chlorine containing composition.

3. A method according to claim 1, wherein the stabilised halogen containing composition (b) comprises chlorosulfamate.

4. A method according to claim 1, wherein the phosphonium compound (a) comprises tri n-butyl n-tetradecyl phosphonium chloride (TTPC).

5. A method according to claim 1, wherein the stabilised halogen containing composition (b) comprises a stabiliser (c) and a halogen containing compound (d) and/or wherein the stabilised halogen containing composition (b) comprises a stabilised halogen containing compound (e).

6. A method according to claim 5, wherein the halogen containing compound (d) comprises sodium hypochlorite and wherein the stabiliser comprises sulfamic acid and wherein the halogen containing compound (e) comprises chlorosulfamate.

7. A method according to claim 1, wherein the method comprises treating said aqueous system to inhibit growth of facultative anaerobic bacteria and/or to reduce the number of live facultative anaerobic bacteria therein.

8. A method according to claim 1, wherein the method comprises treating an aqueous system having a total dissolved solids (TDS) of 30,000 mg l⁻¹ or greater.

9. A method according to claim 1, wherein the method comprises adding a phosphonium compound to said aqueous system in an amount of at least 0.1 ppm.

10. A method according to claim 1, wherein the method comprises adding the composition (b) to provide a treated aqueous system comprising halogen containing compound (d) and/or stabilised halogen containing compound (e) in an amount of at least 0.1 ppm.

11. A method according to claim 1, wherein the method comprises adding stabilised halogen containing composition (b) to said aqueous system in an amount of at least 10 ppm.

12. A method according to claim 1, wherein the method comprises adding a phosphonium compound (a) and a stabilised halogen containing composition (b) to an aqueous system in a weight ratio, expressed as active compound and composition, respectively, of phosphonium compound:stabilised halogen containing composition of from 1.0:0.5 to 1.0:100.0

13. A method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:
(i) tri n-butyl n-tetradecyl phosphonium chloride (TTPC); and
(ii) chlorosulfamate.

14. A method of treating an aqueous system comprising dissolved solids to inhibit growth of one or more micro-organisms therein and/or to reduce the number of live micro-organisms therein, wherein the method comprises adding treatment agents to said aqueous system and wherein said treatment agents comprise:
(i) tri n-butyl n-tetradecyl phosphonium chloride (TTPC); and
(ii) stabilised sodium hypochlorite

15. A method according to claim 14, wherein the method comprises treating an aqueous system having a total dissolved solids (TDS) of 1000 mg l⁻¹ or greater and wherein the method comprises adding TTPC to said aqueous system in an amount of at least 0.1 ppm and adding chlorosulfamate to said aqueous system in an amount of at least 0.1 ppm and wherein the method comprises treating an aqueous system to inhibit growth of facultative anaerobic bacteria and/or to reduce the number of live facultative anaerobic bacteria therein.

16. An aqueous system comprising dissolved solids and incorporating a combination of:
(a) a phosphonium compound; and
(b) a stabilised halogen containing composition.

17. A method of inhibiting or preventing the growth of one or more micro-organisms in an aqueous media, wherein the method comprises adding treatment agents to an aqueous media comprising dissolved solids and wherein said treatment agents comprise:
(a) a phosphonium compound; and
(b) a stabilised halogen containing composition.

18. An aqueous media comprising dissolved solids and incorporating a combination of:
(a) a phosphonium compound; and
(b) a stabilised halogen containing composition.

19. A biocidal composition comprising a combination of:
(a) a phosphonium compound; and
(b) a stabilised halogen containing composition.

20. A method of treating an aqueous system to inhibit growth of one or more micro-organisms therein and/or to reduce the number of live micro-organisms therein, wherein the method comprises adding treatment agents to said aqueous system and wherein said treatment agents comprise:
(a) a phosphonium compound; and
(b) a stabilised halogen containing composition.
